(19) United States
(12) Patent Application Publication
(10) Pub. No.: US 2020/0295627 A1
(43) Pub. Date: Sep. 17, 2020

(54) ROTATING ELECTRIC MACHINE AND MOTOR UNIT

(71) Applicants: HONDA MOTOR CO., LTD., Tokyo (JP); Hitachi Automotive Systems, Ltd., Hitachinaka-shi (JP)

(72) Inventors: Manabu Yazaki, Wako-shi (JP); Atsushi Nishida, Wako-shi (JP); Teruhito Niimi, Wako-shi (JP); Takuji Yano, Wako-shi (JP); Akira Kito, Wako-shi (JP); Sachio Kawada, Hitachinaka-shi (JP); Yasuyuki Saito, Hitachinaka-shi (JP); Hiroshi Hamano, Hitachinaka-shi (JP); Yuji Kobayashi, Hitachinaka-shi (JP)

(21) Appl. No.: 16/815,035

(22) Filed: Mar. 11, 2020

(30) Foreign Application Priority Data
Mar. 12, 2019 (JP) 2019-045186

(51) Int. Cl. H02K 9/193; H02K 5/20

(52) U.S. Cl. CPC H02K 9/193; H02K 5/20

(57) ABSTRACT

A rotating electric machine includes: a cylindrical stator core which includes a plurality of slots; a coil which includes a first coil end inserted into the slot and protruding toward one side of the stator core in an axial direction and a second coil end protruding toward the other side in the axial direction; a rotor which is disposed coaxially with the stator core; a shaft which is disposed coaxially with the rotor; and an end wall which is provided at an end side of the shaft and faces the first coil end in the axial direction. The end wall includes a refrigerant outlet which opens in the axial direction so that a refrigerant supplied from the outside is ejected toward the first coil end.

### CROSS-REFERENCE TO RELATED APPLICATION

Priority is claimed on Japanese Patent Application No. 2019-045186, filed on Mar. 12, 2019, the contents of which are incorporated herein by reference.

### BACKGROUND OF THE INVENTION

### Field of the Invention

The present invention relates to a rotating electric machine and a motor unit.

### Description of Related Art

In a rotating electric machine mounted on a hybrid vehicle, an electric vehicle, or the like, when a current is supplied to a coil, a magnetic field is formed in a stator core and magnetic attraction and repulsion are generated between a rotor (for example, a magnet rotor, a salient pole iron rotor, and a cage rotor) and the stator core. Accordingly, the rotor rotates with respect to the stator.

As the stator used in the rotating electric machine, one including a cylindrical stator core which includes a plurality of slots and a coil which includes a coil end portion inserted into the slot and protruding from an axial end surface of the stator core toward the outside in the axial direction is known. For example, in JP 2011-250655 A, a coil is cooled by a refrigerant flowing from a refrigerant passage disposed above a coil end portion toward the coil end portion. A part of a winding constituting the coil includes an end portion which protrudes again outward in the axial direction from an axial end portion of the coil end portion. An end portion of the winding is provided with a groove which guides a refrigerant toward the axial end portion of the coil end portion.

### SUMMARY OF THE INVENTION

However, when the coil is cooled by the refrigerant flowing from the refrigerant passage disposed above the coil end portion toward the coil end portion, there is a possibility that the refrigerant will not readily permeates to the inner peripheral side of the coil end portion depending on a method of winding the coil around the stator core.

For that reason, there was room for improvement in distributing the refrigerant evenly to the coil end portion.

An aspect of the present invention has been made in view of the above-described circumstances and an object thereof is to provide a rotating electric machine and a motor unit capable of evenly distributing a refrigerant to a coil end portion.

In order to solve the above-described problems and achieve the object, the present invention employs the following aspects.

(1) A rotating electric machine according to an aspect of the present invention includes: a cylindrical stator core which includes a plurality of slots; a coil which includes a first coil end inserted into the slot and protruding toward one side of the stator core in an axial direction and a second coil end protruding toward the other side in the axial direction; a rotor which is disposed coaxially with the stator core; a shaft which is disposed coaxially with the rotor; and an end wall which is provided at an end side of the shaft and faces the first coil end in the axial direction, wherein the end wall includes a refrigerant outlet which opens in the axial direction so that a refrigerant supplied from the outside is ejected toward the first coil end.

(2) In the aspect (1), the first coil end may protrude in a convex bent shape toward one side of the stator core in the axial direction.

(3) A motor unit according to an aspect of the present invention includes: two rotating electric machines according to the aspect (1) or (2), the two rotating electric machines being a first rotating electric machine and a second rotating electric machine disposed coaxially with the first rotating electric machine; a contact surface in which the end wall of the first rotating electric machine comes into contact with the end wall of the second rotating electric machine in the axial direction; and a refrigerant supply path which is provided in the contact surface and is connected to the refrigerant outlet so that the refrigerant supplied from the outside can circulate.

(4) In the aspect (3), the refrigerant supply path may include a groove which is formed in a surface of the end wall of at least one of the first rotating electric machine and the second rotating electric machine.

(5) In the aspect (4), the motor unit may be disposed so that the shaft follows a horizontal direction, the refrigerant outlet may be disposed in an upper portion of the motor unit, and the motor unit may include a refrigerant storage section which has an accommodation space accommodating the first coil end and is able to store the refrigerant ejected from the refrigerant outlet at a lower portion of the motor unit.

According to the aspect (1), since the end wall includes the refrigerant outlet which opens in the axial direction so that the refrigerant supplied from the outside is ejected toward the first coil end, the refrigerant is ejected from the refrigerant outlet toward the first coil end in the axial direction. For that reason, the refrigerant easily permeates to the inner peripheral side of the first coil end as compared with a case in which the refrigerant is ejected toward the first coil end from the outside in the radial direction. Thus, it is possible to evenly distribute the refrigerant to the first coil end.

Incidentally, when the cylindrical casing accommodating the stator and the rotor is provided, there is a high possibility that the refrigerant does not easily reach the portion of the coil that has entered the inside of the casing in the radial direction.

According to this aspect, since the end wall is provided at the end side of the shaft, the refrigerant is easily distributed to the portion having entered the radial inside of the casing in the coil as compared with a case in which the end wall is provided in the middle of the shaft.

According to the aspect (2), since the first coil end protrudes in a convex bent shape toward one side of the stator core in the axial direction, the following effects are obtained. Incidentally, in the case of a so-called SC winding (segment conductor coil) in which a U-shaped conductor is inserted into the slot so that one side is a closed segment and the other side is an open segment, the closed-side conductor is more densely arranged than the open-side conductor and hence the refrigerant easily flows down along the outer peripheral surface. According to this aspect, since the refrigerant is ejected toward the first coil end (the closed-side coil end) in the axial direction, this is suitable for evenly distributing the refrigerant to the closed-side coil end.

In addition, since a configuration for discharging the refrigerant does not need to be provided on the outside of the first coil end in the radial direction as compared with a case in which the refrigerant is ejected toward the first coil end from the outside in the radial direction, the rotating electric machine can be decreased in size in the radial direction.

Additionally, when the second coil end is disposed adjacent to a gear portion, the refrigerant can be ejected from the radial direction toward the second coil end by refrigerant pumping using the gear portion. For this reason, it is sufficient that the refrigerant outlet is disposed only on the side of the first coil end. Accordingly, the refrigerant path can be shortened as compared with a case in which the ejection holes are disposed on both sides of the first coil end and the second coil end and a communication path is provided for the circulation between both ejection holes.

According to the aspect (3), since the motor unit includes the contact surface in which the end wall of the first rotating electric machine comes into contact with the end wall of the second rotating electric machine in the axial direction and the refrigerant supply path which is provided in the contact surface and is connected to the refrigerant outlets so that the refrigerant supplied from the outside can circulate, the refrigerant supply path can be shared (unified) between the first rotating electric machine and the second rotating electric machine. For that reason, the refrigerant path can be shortened as compared with a case in which the refrigerant supply path is separately and independently provided in the first rotating electric machine and the second rotating electric machine. Thus, it is possible to evenly distribute the refrigerant to the first coil ends of two rotating electric machines while shortening the refrigerant path.

According to the aspect (4), since the refrigerant supply path includes the grooves formed in the surfaces of the end walls of at least one of the first rotating electric machine and the second rotating electric machine, it is easy to form the refrigerant supply path as compared with a case in which the refrigerant supply path is formed only as a through-hole.

According to the aspect (5), since the motor unit is disposed so that the shafts follow the horizontal direction and the refrigerant outlets are disposed at the upper portion of the motor unit, the refrigerant ejected from the refrigerant outlets toward the first coil end can flow downward due to its own weight. Additionally, since the motor unit includes the accommodation space which accommodates the first coil end and the refrigerant storage section which can store the refrigerant ejected from the refrigerant outlets at the lower portion of the motor unit, the refrigerant flowing due to the own weight can be stored in the refrigerant storage section. A part (a lower portion) of the first coil end can be immersed by the stored refrigerant. For that reason, it is sufficient that the refrigerant outlets are disposed only at the upper portion of the motor unit. Thus, the refrigerant path can be shortened as compared with a case in which the refrigerant outlets are respectively disposed at the upper portion and the lower portion of the motor unit.

### BRIEF DESCRIPTION OF THE DRAWINGS

FIG. 1 is a front view of a motor unit according to a first embodiment.

FIG. 2 is a rear view of the motor unit according to the first embodiment.

FIG. 3 is a view showing a first rotating electric machine when viewed from the inside of the motor unit in the axial direction in a cross-section of FIG. 1.

FIG. 4 is a view showing a second rotating electric machine when viewed from the inside of the motor unit in the axial direction including a cross-section IV-IV of FIG. 1.

FIG. 5 is a cross-sectional view showing the motor unit including a cross-section V-V of FIG. 3.

FIG. 6 is an enlarged view of a main part of FIG. 5.

FIG. 7 is a perspective view illustrating a flow of a refrigerant of a motor unit according to a first embodiment.

FIG. 8 is a front view illustrating the flow of the refrigerant of the motor unit according to the first embodiment.

FIG. 9 is a view illustrating an action of a refrigerant storage section according to the first embodiment including a cross-section IX-IX of FIG. 2.

FIG. 10 is a cross-sectional view showing a rotating electric machine according to a second embodiment and corresponding to FIG. 5.

### DETAILED DESCRIPTION OF THE INVENTION

Hereinafter, embodiments of the present invention will be described with reference to the drawings. In the embodiments, a motor unit including a rotating electric machine (a traveling motor) mounted on a vehicle such as a hybrid vehicle or an electric vehicle will be described as an example. Hereinafter, a refrigerant supply side to the motor unit from the outside is referred to as a front side and the side opposite to the front side is referred to as a rear side.

[First Embodiment]

<Motor Unit 100>

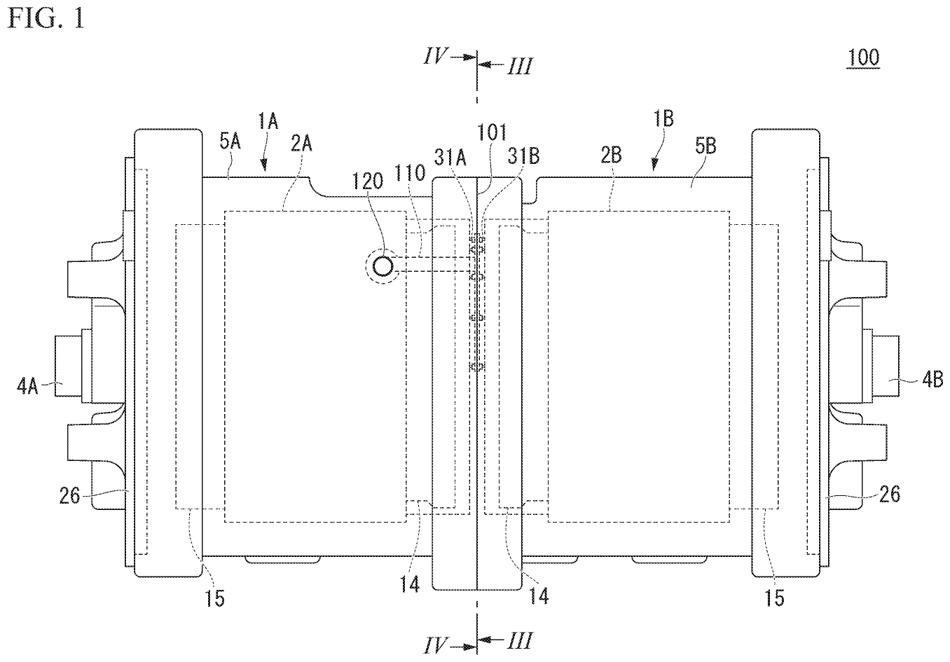

FIG. 1 is a front view of a motor unit 100 according to a first embodiment.

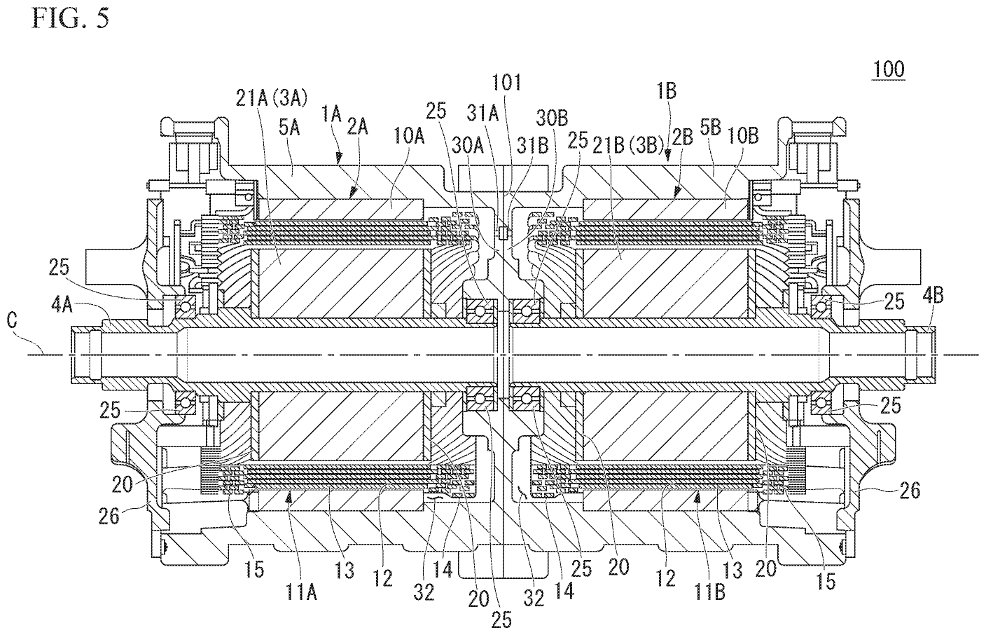

As shown FIG. 1, the motor unit 100 is a twin motor unit including two rotating electric machines 1A and 1B. As shown in FIG. 5, the two rotating electric machines 1A and 1B are the first rotating electric machine 1A and the second rotating electric machine 1B disposed coaxially with the first rotating electric machine 1A. The first rotating electric machine 1A and the second rotating electric machine 1B are disposed so as to be independently rotatable. Hereinafter, a direction along an axis C of the rotating electric machine is referred to as an “axial direction”, a direction orthogonal to the axis C is referred to as a “radial direction”, and a direction around the axis C is referred to as a “circumferential direction”.

In this embodiment, the motor unit 100 is disposed so that the axis C follows the horizontal direction. In the following description, the components of the first rotating electric machine 1A may be denoted by “A” at the end of the reference numerals and the components of the second rotating electric machine 1B may be denoted by “B” at the end of the reference numerals. <First Rotating Electric Machine 1A>

The first rotating electric machine 1A includes a cylindrical first stator 2A, a first rotor 3A disposed coaxially with the first stator 2A, a first shaft 4A disposed coaxially with the first rotor 3A, and a cylindrical first casing 5A accommodating the first stator 2A and the first rotor 3A.

<First Stator 2A>

The first stator 2A includes a first stator core 10A and a plurality of layers (for example, U-phase, V-phase, and W-phase) of first coils 11A mounted on the first stator core 10A. The first stator core 10A generates a magnetic field by allowing a current to flow in the first coil 11A.

The first stator core 10A has a cylindrical shape disposed coaxially with the axis C. The first stator core 10A is fixed to the first casing 5A. The first stator core 10A includes a plurality of slots 12 arranged in the circumferential direction. For example, the first stator core 10A is formed by laminating a plurality of electromagnetic steel sheets (silicon steel sheets) in the axial direction. Additionally, the first stator core 10A may be a so-called dust core obtained by compression-molding a metal magnetic powder (soft magnetic powder).

The first coil 11A is inserted into the slot 12. The first coil 11A has a plurality of conductors arranged in the circumferential direction. The first coil 11A is a so-called SC winding (segment conductor coil) in which a U-shaped conductor is inserted into the slot 12 so that one side is a closed segment and the other side is an open segment. The first coil 11A includes an insertion portion 13 which is inserted into the slot 12 of the first stator core 10A, a first coil end 14 which protrudes toward one side of the first stator core 10A in the axial direction (the inside of the motor unit 100 in the axial direction), and a second coil end 15 which protrudes toward the other side of the first stator core 10A in the axial direction (the outside of the motor unit 100 in the axial direction).

The first coil end 14 is a closed-side coil end. The first coil end 14 protrudes in a convex bent shape toward one side of the first stator core 10A in the axial direction. The first coil end 14 includes conductors arranged more densely than the second coil end 15.

The second coil end 15 an open-side coil end. In the second coil end 15, the conductor end portions are joined to each other and are subjected to coating with a protective paint in order to insulate this joint portion. For example, coating with a protective paint is so-called powder coating in which a powder is adhered to a conductor and then the powder is heated to form a protective film. In this embodiment, the second coil end 15 is subjected to powder coating. Meanwhile, the first coil end 14 is not subjected to powder coating.

<First Rotor 3A>

The first rotor 3A is radially disposed inward with respect to the first stator 2A with a gap interposed therebetween. The first rotor 3A is fixed to the first shaft 4A. The first rotor 3A is configured to be rotatable around the axis C together with the first shaft 4A. The first rotor 3A includes a first rotor core 21A and a magnet (not shown). For example, the magnet is a permanent magnet. Reference numeral 20 in the drawing denotes an end surface plate disposed at both ends of the first rotor 3A in the axial direction.

The first rotor core 21A has a cylindrical shape disposed coaxially with the axis

C. The first rotor core 21A is formed by laminating a plurality of electromagnetic steel sheets (silicon steel sheets) in the axial direction. Additionally, the first rotor core 21A may be a so-called dust core obtained by compression-molding a metal magnetic powder (soft magnetic powder).

<First Shaft 4A>

The first shaft 4A has a hollow structure opening in the axial direction. The axial center portion of the first shaft 4A is fixed into the first rotor core 21A in the radial direction by press-inserting and fixing. Both end portions of the first shaft 4A in the axial direction are supported by a bearing 25 inside the first casing 5A.

<First Casing 5A>

The first casing 5A includes an end wall 30A provided at one end portion (end side) of the first shaft 4A. The end wall 30A faces the first coil end 14 in the axial direction. The end wall 30A includes a refrigerant outlet 31A which opens in the axial direction so that the refrigerant supplied from the outside is ejected toward the first coil end 14. The refrigerant outlet 31A is disposed at the upper portion of the motor unit 100. The refrigerant outlet 31A is not disposed at the lower portion of the motor unit 100. Reference numeral 26 in the drawing denotes a cover which is provided in the other end portion of the first shaft 4A and covers the second coil end 15 from the axial direction.

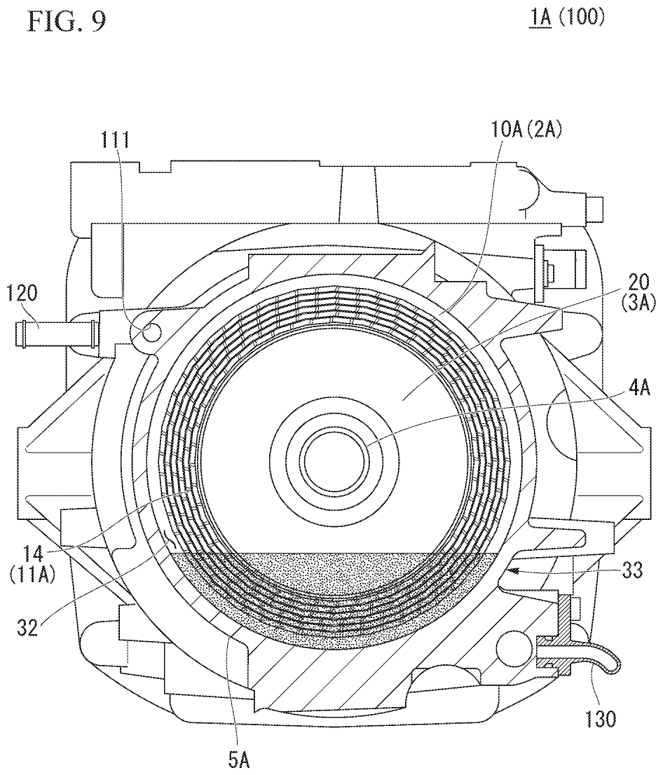

The first casing 5A includes an accommodation space 32 which accommodates the first coil end 14. The first casing 5A includes a refrigerant storage section 33 which can store the refrigerant ejected from the refrigerant outlet 31A at the lower portion of the motor unit 100 (see FIG. 9). As shown in FIG. 9, the refrigerant stored in the refrigerant storage section 33 immerses the first stator 2A in the lower portion of the motor unit 100. For example, as the refrigerant, automatic transmission fluid (ATF) or the like which is a hydraulic oil used for lubrication of a transmission, power transmission, or the like is preferably used.

<Second Rotating Electric Machine 1B>

As shown in FIG. 5, the second rotating electric machine 1B includes a cylindrical second stator 2B, a second rotor 3B disposed coaxially with the second stator 2B, a second shaft 4B disposed coaxially with the second rotor 3B, and a cylindrical second casing 5B accommodating the second stator 2B and the second rotor 3B. In the second rotating electric machine 1B, the same components as those of the first rotating electric machine 1A are denoted by the same reference numerals and detailed description thereof will be omitted.

The second casing 5B includes an end wall 30B provided at one end portion (end side) of the second shaft 4B. The end wall 30B comes into contact with the end wall 30A of the first rotating electric machine 1A in the axial direction. The end wall 30B is coupled to the end wall 30A of the first rotating electric machine 1A by a fastening member such as a bolt. The end wall 30B faces the first coil end 14 in the axial direction. The end wall 30B includes a refrigerant outlet 31B which opens in the axial direction so that the refrigerant supplied from the outside is ejected toward the first coil end 14. The refrigerant outlet 31B communicates with the refrigerant outlet 31A of the first rotating electric machine 1A in the axial direction.

<Contact Surface 101>

The motor unit 100 includes a contact surface 101 in which the end wall 30A (hereinafter, referred to as the “first end wall 30A”) of the first rotating electric machine 1A comes into contact with the end wall (hereinafter, referred to as the “second end wall 30B”) of the second rotating electric machine 1B in the axial direction. The contact surface 101 is a joint surface (a boundary surface) between the first rotating electric machine 1A and the second rotating electric machine 1B. The first rotating electric machine 1A and the second rotating electric machine 1B has a symmetrical structure in which an imaginary line following the contact surface 101 is a symmetrical axis. That is, the second rotating electric machine 1B has a shape obtained by mirror-inverting the first rotating electric machine 1A.

<Refrigerant Path 110>

As shown in FIG. 1, the refrigerant path 110 is connected to the refrigerant outlets 31A and 31B so that the refrigerant supplied from the outside can circulate. The refrigerant path 110 is disposed at the upper portion of the motor unit 100. The refrigerant path 110 is not disposed at the lower portion of the motor unit 100.

Reference numeral 120 in the drawing denotes a refrigerant introduction pipe which introduces the refrigerant from the outside and reference numeral 130 denotes a refrigerant outlet pipe which leads the refrigerant ejected from the refrigerant outlets 31A and 31B to the outside. Hereinafter, an upstream side in the refrigerant flow direction may be simply referred to as an “upstream side” and a downstream side in the refrigerant flow direction may be simply referred to as a “downstream side”.

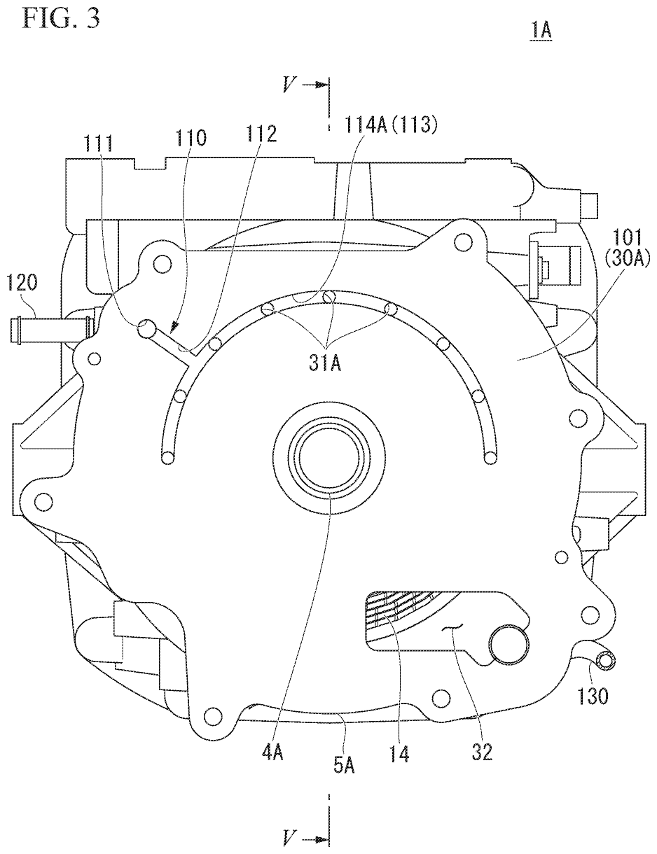

As shown in FIG. 3, the refrigerant path 110 includes a first introduction path 111 which introduces the refrigerant introduced from the refrigerant introduction pipe 120 into the contact surface 101, a refrigerant supply path 113 which is provided in the contact surface 101, and a second introduction path 112 which introduces the refrigerant introduced from the first introduction path 111 into the refrigerant supply path 113.

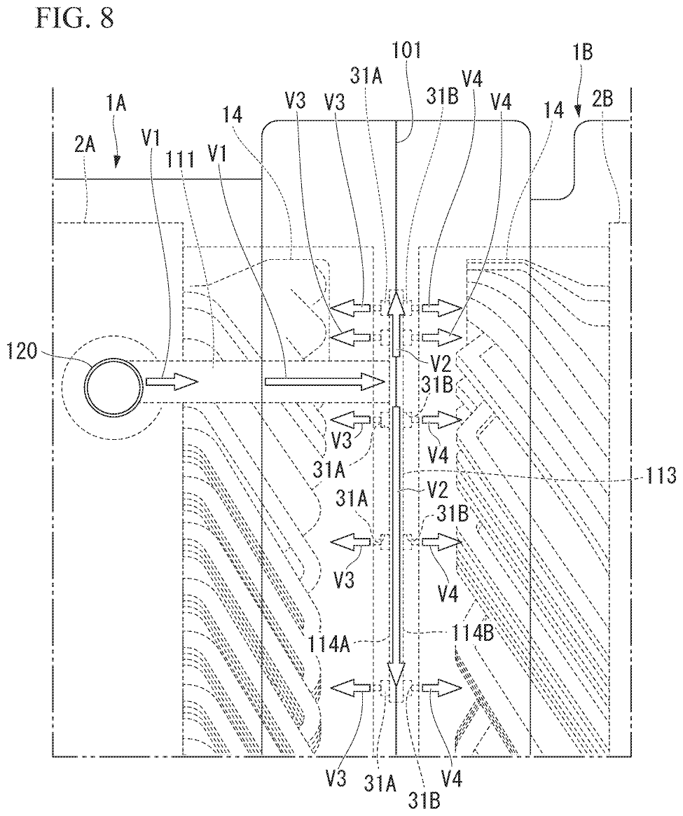

The first introduction path 111 is provided in the first casing 5A. The first introduction path 111 extends in the axial direction from the downstream end of the refrigerant introduction pipe 120 to the contact surface 101 (see FIG. 8).

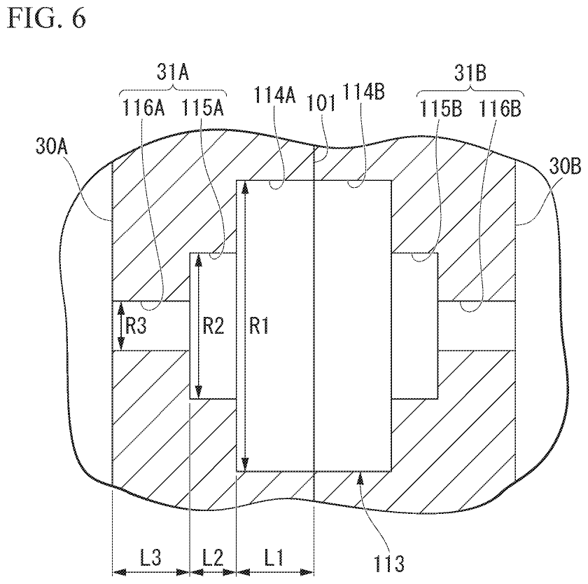

The refrigerant supply path 113 includes a first groove 114A which is formed in the surface of the first end wall 30A (the surface facing the second end wall 30B) and a second groove 114B which is formed in the surface of the second end wall 30B (the surface facing the first end wall 30A) (see FIG. 6).

The first groove 114A has an arc shape that is convex upward. The first groove 114A is disposed at a position overlapping the first coil end 14 (the closed-side coil end) in the first rotating electric machine 1A in the axial direction.

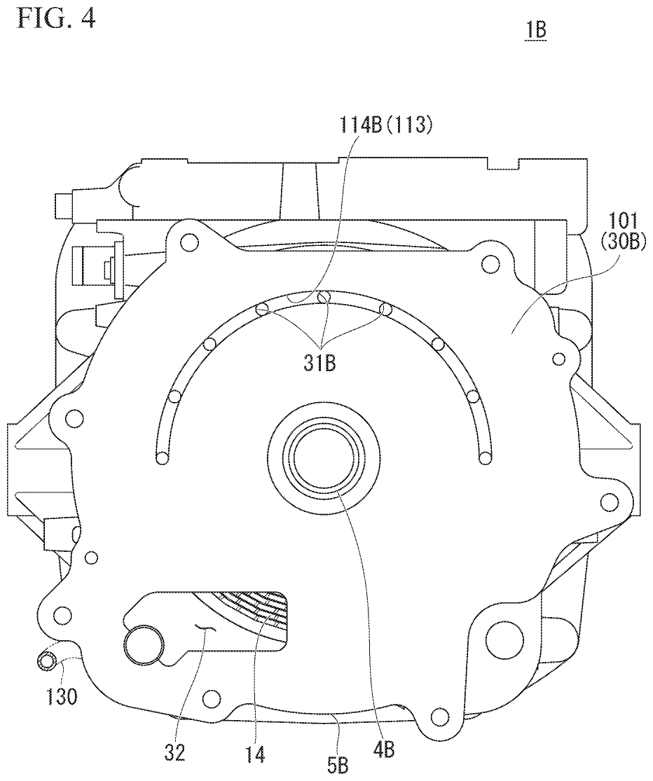

As shown in FIG. 4, the second groove 114B has an arc shape that is convex upward. The second groove 114B is disposed at a position overlapping the first groove 114A in the axial direction (see FIG. 6). The second groove 114B is disposed at a position overlapping the first coil end 14 (the closed-side coil end) in the second rotating electric machine 1B in the axial direction.

As shown in FIG. 3, the second introduction path 112 is provided in the contact surface 101. The second introduction path 112 is a groove which is provided in the surface of the first end wall 30A. The second introduction path 112 extends from the downstream end of the first introduction path 111 to the first groove 114A. The second introduction path 112 is inclined with respect to the horizontal direction so as to be located further downward as it goes toward the first groove 114A.

<Refrigerant Outlets 31A and 31B>

As shown in FIG. 6, the refrigerant outlets 31A and 31B include the first ejection hole 31A connected to the first groove 114A and the second ejection hole 31B connected to the second groove 114B.

The first ejection hole 31A is disposed at a position overlapping the first groove 114A in the axial direction. A plurality of (for example, nine in the embodiment) first ejection holes 31A are disposed at the substantially same intervals in the circumferential direction (see FIG. 3).

The first ejection hole 31A includes a first communication portion 115A which communicates with the first groove 114A and a first ejection portion 116A which is disposed coaxially with the first communication portion 115A.

The first communication portion 115A has a circular cross-section. An outer diameter R2 of the first communication portion 115A is smaller than a groove width R1 of the first groove 114A (R2<R1). An axial length L2 of the first communication portion 115A is smaller than a depth L1 of the first groove 114A (L2<L1).

The first ejection portion 116A has a circular cross-section. An outer diameter R3 of the first ejection portion 116A is smaller than the outer diameter R2 of the first communication portion 115A (R3<R2). An axial length L3 of the first ejection portion 116A is longer than the axial length L2 of the first communication portion 115A (L3>L2).

The second ejection hole 31B is disposed on the side opposite to the first ejection hole 31A between the first groove 114A and the second groove 114B. The second ejection hole 31B is disposed at a position overlapping the second groove 114B in the axial direction. A plurality of (for example, nine in the embodiment) second ejection holes 31B are disposed at the substantially same intervals in the circumferential direction (see FIG. 4). Each of the plurality of second ejection holes 31B communicates with the first ejection hole 31A in the axial direction (see FIG. 8).

The second ejection hole 31B includes a second communication portion 115B which communicates with the second groove 114B and a second ejection portion 116B which is disposed coaxially with the second communication portion 115B.

The second communication portion 115B has a circular cross-section substantially the same size as the first communication portion 115A. The outer diameter of the second communication portion 115B is smaller than the groove width of the second groove 114B. The axial length of the second communication portion 115B is smaller than the depth of the second groove.

The second ejection portion 116B has a circular cross-section substantially the same size as the first ejection portion 116A.

<Flow of Refrigerant>

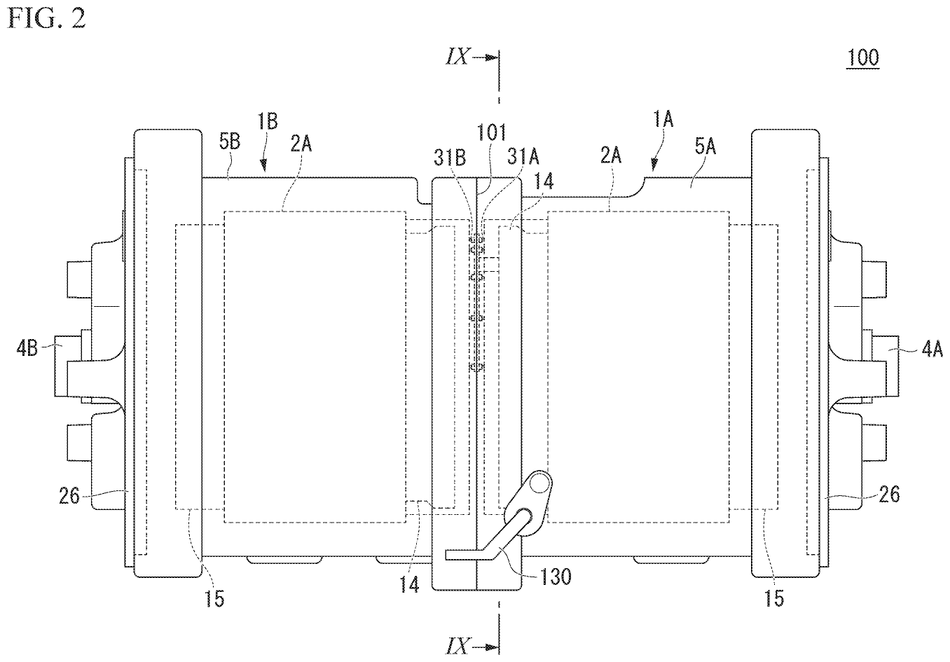

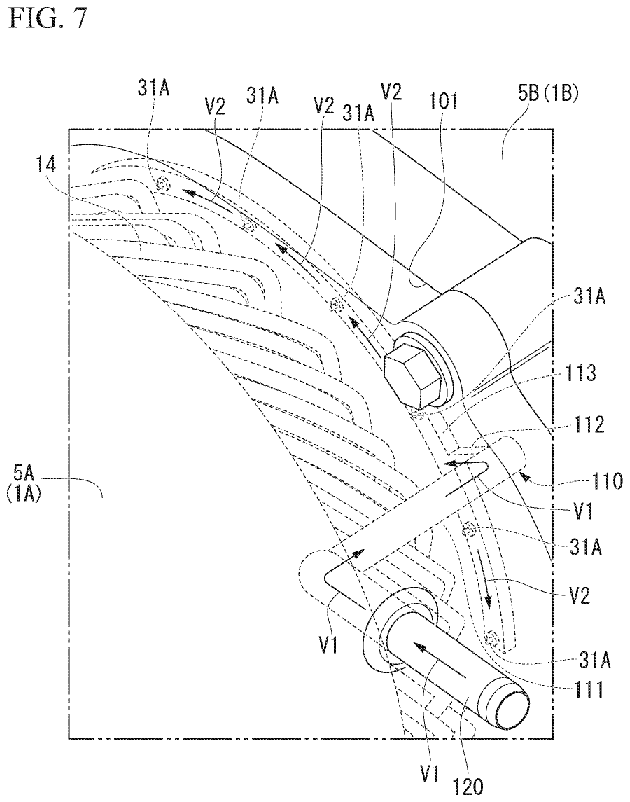

FIG. 7 is a perspective view illustrating a flow of the refrigerant of the motor unit 100 according to the first embodiment. FIG. 8 is a front view illustrating a flow of the refrigerant of the motor unit 100 according to the first embodiment. FIG. 9 is a view illustrating an operation of the refrigerant storage section 33 according to the first embodiment in a cross-section IX-IX of FIG. 2.

As shown in FIG. 7, the refrigerant supplied from the outside is introduced into the refrigerant supply path 113 through the refrigerant introduction pipe 120, the first introduction path 111, and the second introduction path 112 (see an arrow V1 in the drawing). Then, the refrigerant flows in the circumferential direction along the refrigerant supply path 113 (see an arrow V2 in the drawing).

Then, the refrigerant is introduced into the refrigerant outlets 31A and 31B and is ejected toward the first coil end 14 (see FIG. 8). As shown in FIG. 8, the refrigerant is ejected toward the first coil end 14 (the closed-side coil end) in the first rotating electric machine 1A through the first ejection hole 31A (see an arrow V3 in the drawing) and is ejected toward the first coil end 14 (the closed-side coil end) in the second rotating electric machine 1B through the second ejection hole 31B (see an arrow V4 in the drawing).

A part of the refrigerant ejected from the refrigerant outlets 31A and 31B is stored in the refrigerant storage section 33 at the lower portion of the motor unit 100 (see FIG. 9). A part of the refrigerant stored in the refrigerant storage section 33 immerses the first stator 2A and the second stator 2B at the lower portion of the motor unit 100. The remaining part of the refrigerant stored in the refrigerant storage section 33 is let out through the refrigerant outlet pipe 130. Additionally, the downstream end of the refrigerant outlet pipe 130 may be connected to a return flow path (a return path (not shown)) for returning the refrigerant to the refrigerant introduction pipe 120, another cooling flow path, or the like.

As described above, the motor unit 100 of the above-described embodiment includes the cylindrical stator core 10A (10B) which includes the plurality of slots 12, the coil 11A (11B) which includes the first coil end 14 inserted into the slot 12 and protruding toward one side of the stator core 10A (10B) in the axial direction and the second coil end 15 protruding toward the other side in the axial direction, the rotor 3A (3B) which is disposed coaxially with the stator core 10A (10B), the shaft 4A (4B) which is disposed coaxially with the rotor 3A (3B), and the end wall 30A (30B) which is provided at the end side of the shaft 4A (4B) and faces the first coil end 14 in the axial direction and the end wall 30A (30B) includes the refrigerant outlet 31A (31B) which opens in the axial direction so that the refrigerant supplied from the outside is ejected toward the first coil end 14.

According to this configuration, since the end wall 30A (30B) includes the refrigerant outlet 31A (31B) which opens in the axial direction so that the refrigerant supplied from the outside is ejected toward the first coil end 14, the refrigerant is ejected from the refrigerant outlet 31A (30B) toward the first coil end 14 in the axial direction. For that reason, the refrigerant easily permeates to the inner peripheral side of the first coil end 14 as compared with a case in which the refrigerant is ejected toward the first coil end 14 from the outside in the radial direction. Thus, the refrigerant can be evenly distributed to the first coil end 14.

Incidentally, when the cylindrical casing accommodating the stator and the rotor is provided, there is a high possibility that the refrigerant does not easily reach the portion of the coil that has entered the inside of the casing in the radial direction.

According to this configuration, since the end wall 30A (30B) is provided at the end side of the shaft 4A (4B), the refrigerant is easily distributed to the portion having entered the inside of the casing 5A (5B) in the radial direction in the coil 11A (11B) as compared with a case in which the end wall is provided in the middle of the shaft.

In the above-described embodiment, since the first coil end 14 protrudes in a convex bent shape at one axial side of the stator core 10A (10B), the following effects are obtained. Incidentally, when the coil is the SC winding, the closed-side conductor is more densely arranged than the open-side conductor and hence the refrigerant easily flows down along the outer peripheral surface. According to this configuration, since the refrigerant is ejected toward the first coil end 14 (the closed-side coil end) in the axial direction, this is suitable for evenly distributing the refrigerant to the closed-side coil end.

In addition, since a configuration for discharging the refrigerant does not need to be provided on the outside of the first coil end 14 in the radial direction as compared with a case in which the refrigerant is ejected toward the first coil end 14 from the outside in the radial direction, the motor unit 100 can be decreased in size in the radial direction.

Additionally, when the second coil end 15 is disposed adjacent to a gear portion, the refrigerant can be ejected from the radial direction toward the second coil end 15 by refrigerant pumping using the gear portion. For this reason, it is sufficient that the refrigerant outlet 31A (31B) is disposed only on the side of the first coil end 14. Accordingly, the refrigerant path 110 can be shortened as compared with a case in which the ejection holes are disposed on both sides of the first coil end 14 and the second coil end 15 and a communication path is provided for the circulation between both ejection holes.

In the above-described embodiment, the motor unit 100 includes two rotating electric machines 1A and 1B. Two rotating electric machines 1A and 1B are the first rotating electric machine 1A and the second rotating electric machine 1B disposed coaxially with the first rotating electric machine 1A. The motor unit 100 includes the contact surface 101 in which the end wall 30A of the first rotating electric machine 1A comes into contact with the end wall 30B of the second rotating electric machine 1B in the axial direction and the refrigerant supply path 113 which is provided in the contact surface 101 and is connected to the refrigerant outlet so that the refrigerant supplied from the outside can circulate.

According to this configuration, since the motor unit 100 includes the contact surface 101 in which the end wall of the first rotating electric machine 1A comes into contact with the end wall of the second rotating electric machine 1B in the axial direction and the refrigerant supply path 113 which is provided in the contact surface 101 and is connected to the refrigerant outlets 31A and 31B so that the refrigerant supplied from the outside can circulate, the refrigerant supply path 113 can be shared (unified) between the first rotating electric machine 1A and the second rotating electric machine 1B. For that reason, the refrigerant path 110 can be shortened as compared with a case in which the refrigerant supply path 113 is separately and independently provided in the first rotating electric machine 1A and the second rotating electric machine 1B. Thus, it is possible to evenly distribute the refrigerant to the first coil ends 14 of two rotating electric machines 1A and 1B while shortening the refrigerant path 110.

In the above-described embodiment, since the refrigerant supply path 113 includes the grooves 114A and 114B formed in the surfaces of the end walls 30A and 30B of at least one of the first rotating electric machine 1A and the second rotating electric machine 1B, it is easy to form the refrigerant supply path 113 as compared with a case in which the refrigerant supply path 113 is formed only as a through-hole.

In the above-described embodiment, since the motor unit 100 is disposed so that the shafts 4A and 4B follow the horizontal direction and the refrigerant outlets 31A and 31B are disposed at the upper portion of the motor unit 100, the refrigerant ejected from the refrigerant outlets 31A and 31B toward the first coil end 14 can flow downward due to its own weight. Additionally, since the motor unit 100 includes the accommodation space 32 which accommodates the first coil end 14 and the refrigerant storage section 33 which can store the refrigerant ejected from the refrigerant outlets 31A and 31B at the lower portion of the motor unit 100, the refrigerant flowing due to the own weight can be stored in the refrigerant storage section 33. A part (a lower portion) of the first coil end 14 can be immersed by the stored refrigerant. For that reason, it is sufficient that the refrigerant outlets 31A and 31B are disposed only at the upper portion of the motor unit 100. Thus, the refrigerant path 110 can be shortened as compared with a case in which the refrigerant outlets 31A and 31B are respectively disposed at the upper portion and the lower portion of the motor unit 100.

[Modified Example of First Embodiment]

In the above-described embodiment, a configuration in which the refrigerant supply path 113 includes the first groove 114A formed in the surface of the first end wall 30A and the second groove 114B formed in the surface of the second end wall 30B has been described, but the present invention is not limited thereto. For example, the refrigerant supply path 113 may be a groove formed only at one of the surface of the first end wall 30A and the surface of the second end wall 30B. For example, the refrigerant supply path 113 may be formed by a combination of a groove and a through-hole. For example, the refrigerant supply path 113 may be formed only by a through-hole.

In the above-described embodiment, a configuration in which the refrigerant supply path 113 is shared (unified) between the first rotating electric machine 1A and the second rotating electric machine 1B has been described, but the present invention is not limited thereto. For example, the refrigerant supply path 113 may be separately and independently provided in the first rotating electric machine 1A and the second rotating electric machine 1B.

In the above-described embodiment, a configuration in which the refrigerant outlets 31A and 31B are disposed only at the upper portion of the motor unit 100 has been described, but the present invention is not limited thereto. For example, the refrigerant outlets 31A and 31B may be respectively disposed at the upper portion and the lower portion of the motor unit 100.

In the above-described embodiment, a configuration in which the plurality of refrigerant outlets 31A and 31B are arranged at the substantially same intervals in the circumferential direction has been described, but the present invention is not limited thereto. For example, the arrangement intervals of the refrigerant outlets 31A and 31B in the circumferential direction need not be the same and may be unequal intervals.

In the above-described embodiment, a configuration in which the motor unit 100 is disposed so that the shafts 4A and 4B follow the horizontal direction has been described, but the present invention is not limited thereto. For example, the motor unit 100 may be disposed so that the shafts 4A and 4B follow the vertical direction. The arrangement of the shafts 4A and 4B can be changed to an arbitrary direction in accordance with the design specification.

In the above-described embodiment, a configuration in which the coil is the SC winding has been described, but the present invention is not limited thereto. For example, the coil may be a continuous winding or the like other than the SC winding.

For example, the coil may have a shape with a straight conductor inserted into the slot and twisted on both sides. For example, the coil may protrude without a bent shape that is convex outward in the axial direction.

[Second Embodiment]

Hereinafter, a second embodiment of the present invention will be described. In the second embodiment, the same components as those of the first embodiment are denoted by the same reference numerals and detailed description thereof will be omitted.

In the first embodiment, a configuration in which the motor unit is a twin motor unit including two rotating electric machines has been described, but the present invention is not limited thereto. For example, the motor unit may be a single motor unit including a single rotating electric machine.

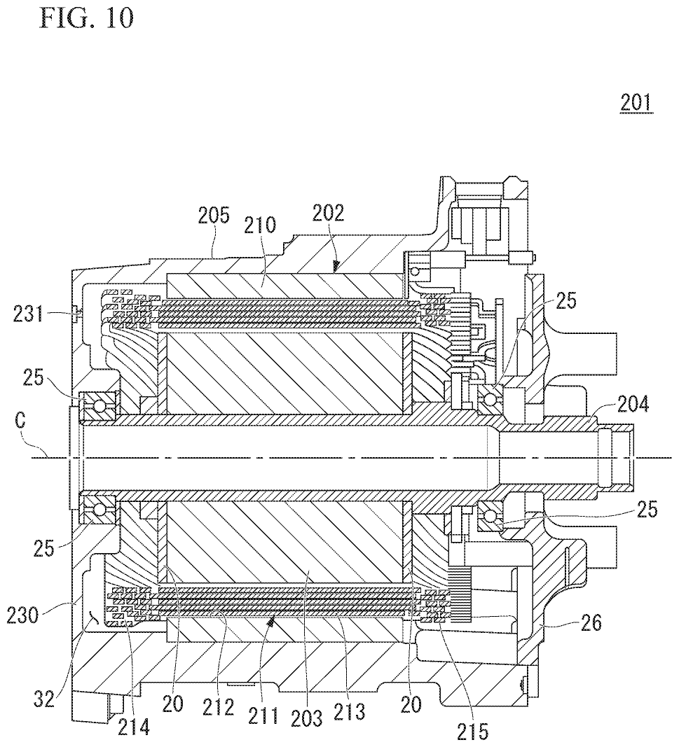

FIG. 10 is a cross-sectional view showing a rotating electric machine 201 according to the second embodiment and corresponding to FIG. 5.

As shown in FIG. 10, the rotating electric machine 201 includes a cylindrical stator 202, a rotor 203 disposed coaxially with the stator 202, a shaft 204 disposed coaxially with the rotor 203, and a cylindrical casing 205 accommodating the stator 202 and the rotor 203.

The stator 202 includes a cylindrical stator core 210 including a plurality of slots 212 and a coil 211 inserted into the slot 212. The coil 211 includes an insertion portion 213 which is inserted into the slot 212 of the stator core 210, a first coil end 214 which protrudes in a convex bent shape toward one side of the stator core 210 in the axial direction, and a second coil end 215 which protrudes toward the other side in the axial direction.

The casing 205 includes an end wall 230 which is provided in an end portion of the shaft 204 and faces the first coil end 214 in the axial direction. The end wall 230 includes a refrigerant outlet 231 which opens in the axial direction so that the refrigerant supplied from the outside is ejected toward the first coil end 214.

As described above, the rotating electric machine 201 of the embodiment includes the cylindrical stator core 210 which includes the plurality of slots 212, the coil 211 which includes the first coil end 214 inserted into the slot 212 and protruding in a convex bent shape toward one side of the stator core 210 in the axial direction and the second coil end 215 protruding toward the other side in the axial direction, the rotor 203 which is disposed coaxially with the stator core 210, the shaft 204 which is disposed coaxially with the rotor 203, and the end wall 230 which is provided in the end portion of the shaft 204 and faces the first coil end 214 in the axial direction and the end wall 230 includes the refrigerant outlet 231 which opens in the axial direction so that the refrigerant supplied from the outside is ejected toward the first coil end 214.

According to this configuration, since the end wall 230 includes the refrigerant outlet 231 which opens in the axial direction so that the refrigerant supplied from the outside is ejected toward the first coil end 214, the refrigerant is ejected from the refrigerant outlet 231 toward the first coil end 214 in the axial direction. For that reason, the refrigerant easily permeates to the inner peripheral side of the first coil end 214 as compared with a case in which the refrigerant is ejected toward the first coil end 214 from the radial outside. Thus, the refrigerant can be evenly distributed to the first coil end 214.

Incidentally, when the coil is the SC winding, the closed-side conductor is more densely arranged than the open-side conductor and hence the refrigerant easily flows down along the outer peripheral surface. According to this configuration, since the refrigerant is ejected toward the first coil end 214 (the closed-side coil end) in the axial direction, this is suitable for evenly distributing the refrigerant to the closed-side coil end.

Additionally, since a configuration for discharging the refrigerant does not need to be provided on the radial outside of the first coil end 214 as compared with a case in which the refrigerant is ejected toward the first coil end 214 at the radial outside, the rotating electric machine 201 can be decreased in size in the radial direction.

In addition, when the second coil end 215 is disposed adjacent to a gear portion, the refrigerant can be ejected from the radial direction toward the second coil end 215 by refrigerant pumping using the gear portion. For this reason, it is sufficient that the refrigerant outlet 231 is disposed only on the side of the first coil end 214. Accordingly, the refrigerant path can be shortened as compared with a case in which the ejection holes are disposed on both sides of the first coil end 214 and the second coil end 215 and a communication path is provided for the circulation between both ejection holes.

In the above-described embodiment, an example has been described in which the rotating electric machine is a traveling motor mounted on a vehicle such as a hybrid vehicle or an electric vehicle, but the present invention is not limited thereto. For example, the rotating electric machine may be a motor for power generation or other uses or a rotating electric machine (including a generator) other than for a vehicle.

Although the preferred embodiments of the present invention have been described above, the present invention is not limited thereto and additions, omissions, substitutions, and other modifications of the configuration can be made without departing from the spirit of the invention. Furthermore, the above-described modifications can be appropriately combined.

What is claimed is:

1. A rotating electric machine comprising:
a cylindrical stator core which includes a plurality of slots;
a coil which includes a first coil end inserted into the slot and protruding toward one side of the stator core in an axial direction and a second coil end protruding toward the other side in the axial direction;
a rotor which is disposed coaxially with the stator core;
a shaft which is disposed coaxially with the rotor; and
an end wall which is provided at an end side of the shaft and faces the first coil end in the axial direction,
wherein the end wall includes a refrigerant outlet which opens in the axial direction so that a refrigerant supplied from the outside is ejected toward the first coil end.

2. The rotating electric machine according to claim 1,
wherein the first coil end protrudes in a convex bent shape toward one side of the stator core in the axial direction.

3. A motor unit comprising:
two rotating electric machines according to claim 1, the two rotating electric machines being a first rotating electric machine and a second rotating electric machine disposed coaxially with the first rotating electric machine;
a contact surface in which the end wall of the first rotating electric machine comes into contact with the end wall of the second rotating electric machine in the axial direction; and
a refrigerant supply path which is provided in the contact surface and is connected to the refrigerant outlet so that the refrigerant supplied from the outside circulates.

4. The motor unit according to claim 3,
wherein the refrigerant supply path includes a groove which is formed in a surface of the end wall of at least one of the first rotating electric machine and the second rotating electric machine.

5. The motor unit according to claim 4,
wherein the motor unit is disposed so that the shaft follows a horizontal direction,
wherein the refrigerant outlet is disposed in an upper portion of the motor unit, and
wherein the motor unit comprises a refrigerant storage section which has an accommodation space accommodating the first coil end and is able to store the refrigerant ejected from the refrigerant outlet at a lower portion of the motor unit.
